(19) United States
(12) Patent Application Publication
(10) Pub. No.: US 2004/0164966 A1
(43) Pub. Date: Aug. 26, 2004

(54) Touch panel display device

(76) Inventor: Wang-Tsai Lee, Pan Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/372,188

(22) Filed: Feb. 25, 2003

(51) Int. Cl. G09G 5/00

(52) U.S. Cl. 345/173

(57) ABSTRACT

A touch panel display device that is easily produced with a lower cost and has moisture-proof and dust-proof properties includes an upper casing, a lower casing, a touch control module and a circuit board. The upper casing includes a display part and a remaining part surrounding the display part. The lower casing is mounted corresponding to the upper casing to define a space therein. The touch control module is located under a bottom of the upper casing in the defined space. The circuit board is located between the touch control module and the lower casing in the defined space. The display part and the remaining part of the upper casing are integrally formed in a single body with no gap or slit there between. A bottom of the display part is correspondingly attached to a top of the touch control module.

### BACKGROUND OF THE INVENTION

1. Field of the Invention

The invention relates to a touch panel display device and, more particularly, to a touch panel display device that is provided with a touch control module by means of which a user manually operates the touch panel display device.

2. Description of the Related Art

Referring to FIG. 1, a conventional touch panel display includes an upper casing 1, a lower casing 2, a touch panel control module 3 and a circuit board 4. The upper casing 1 has a central opening 11.

The upper and lower casing 1 and 2 are mounted corresponding to each other to define a space for receiving the touch control module 3 and the circuit board 4. The touch control module 3 is located directly under the opening 11 of the upper casing. A film 12 is further attached on the touch control module 3 and is exposed through the opening 11. The circuit board 4 is mounted between the touch control module 3 and the lower casing 2.

When a user manually touches the touch panel screen to perform, for example, writing operations, he/she particularly touches the film 12 through the opening 11, and the touch control module 3 under the film 12 is actuated to send out a corresponding command signal to achieve an input operation.

However, the touch panel display known in the art has the following disadvantages.

1. The upper casing 1 must be formed with the central opening 11 and the film 12, which increases the production cost.

2. Usually, there is a gap or slit between the opening 11 and the film 12 through which dust or moisture easily penetrates, which may cause a display failure.

### SUMMARY OF THE INVENTION

It is therefore a principal object of the invention to provide a touch panel display device that has an integrally formed upper casing, and a touch control module. The upper casing includes a display part and a remaining part surrounding the display part. A bottom of the display part is correspondingly attached on a top of the touch control module.

The display part and the remaining part of the upper casing are integrally formed without the need of any additional film or opening. The touch panel display device of the invention therefore is easily produced with a reduced cost.

Furthermore, there is no gap or slit between the display part and the remaining part so that dust or moisture penetration is prevented. Therefore, a consequent display failure is prevented.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a cross-sectional view of a conventional touch panel display;

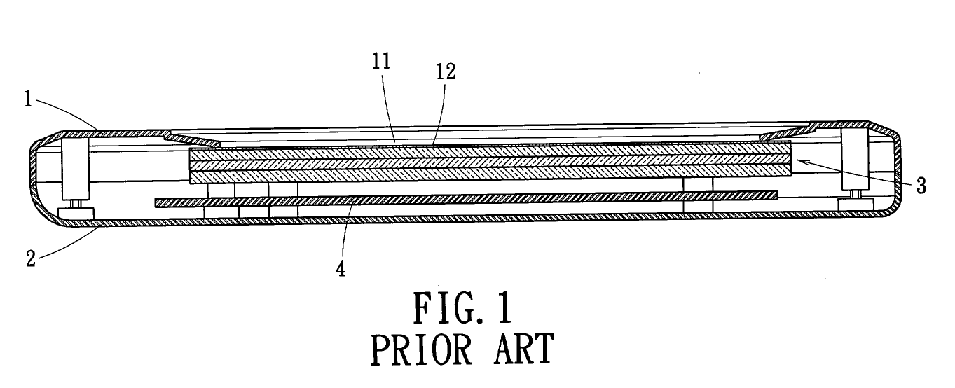

FIG. 2 is a perspective view of an upper casing of a touch panel display device before painting according to one embodiment of the invention;

FIG. 3 is a perspective view of an upper casing of a touch panel display device after painting according to one embodiment of the invention;

FIG. 4 is a cross-sectional view of FIG. 3;

FIG. 5 is an exploded view of a touch panel display device according to one embodiment of the invention;

FIG. 6 is perspective view illustrating a touch panel display device after being assembled according to one embodiment of the invention; and

FIG. 7 is a cross-sectional view of FIG. 6.

### DETAILED DESCRIPTION OF THE EMBODIMENTS

Wherever possible in the following description, like reference numerals will refer to like elements and parts unless otherwise illustrated.

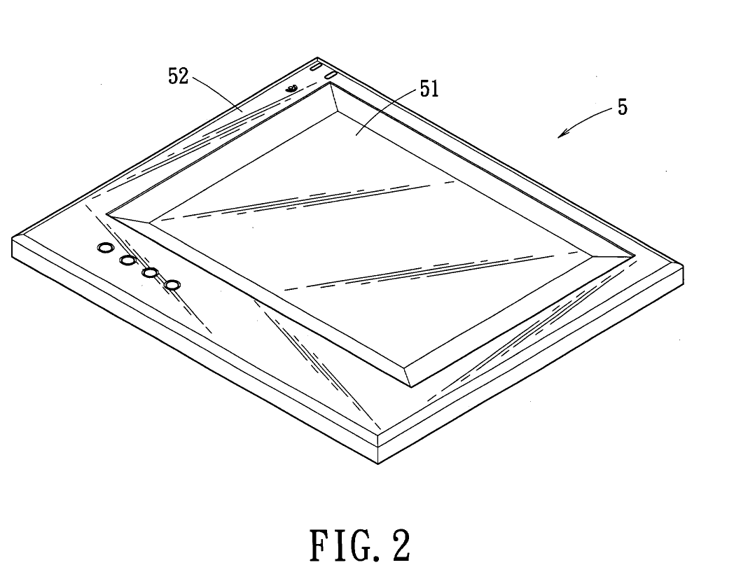

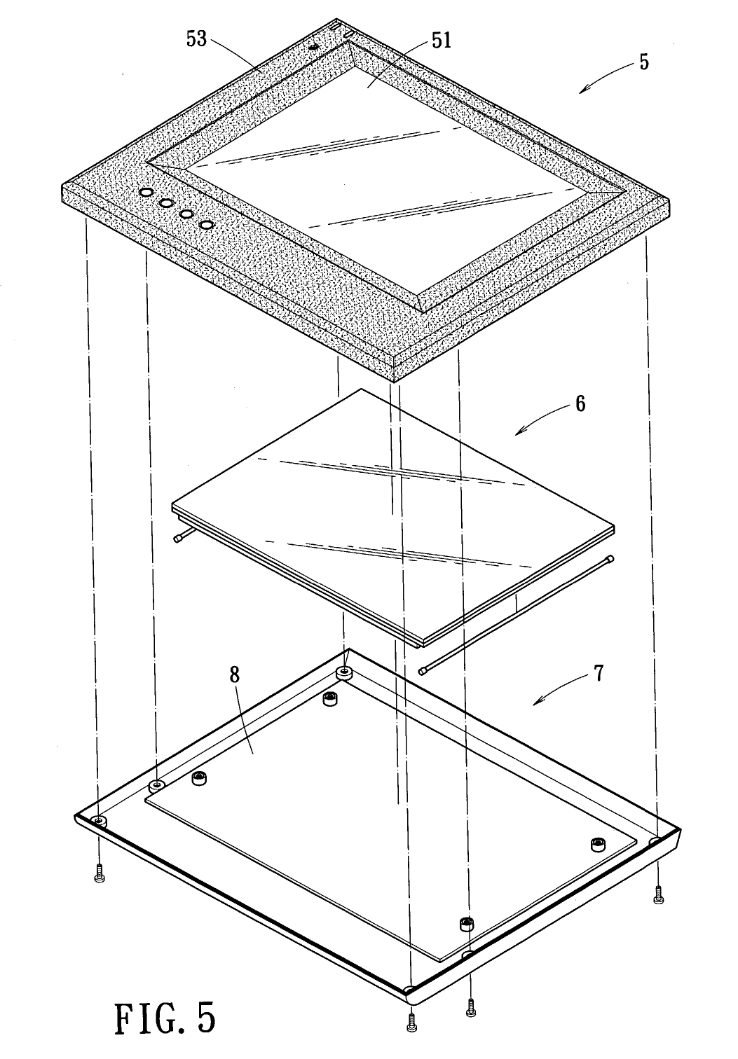

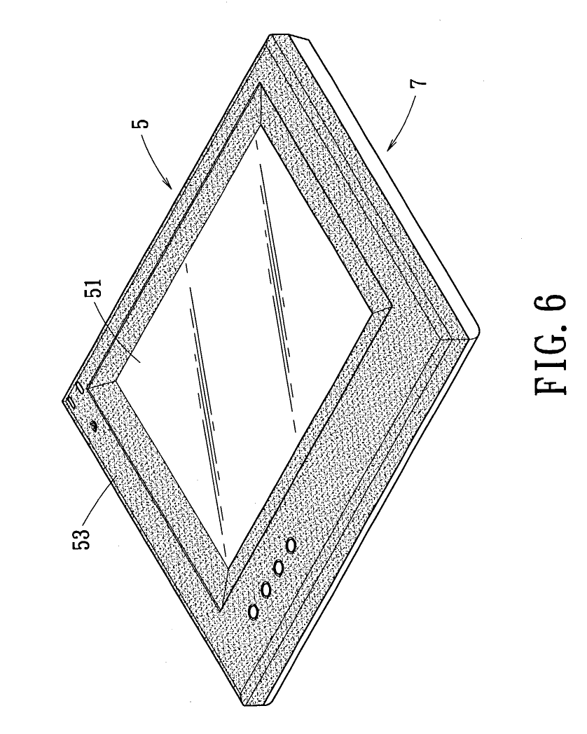

FIG. 2 through FIG. 4 show an upper casing 5 of a touch panel display device according to one embodiment of the invention. FIG. 5 through FIG. 7 illustrate the assembly of the touch panel display device according to one embodiment of the invention.

Referring FIG. 2 through 4, an upper casing 5 including a display part 51 and a peripheral part 52 is integrally formed in a single body. The display part 51 is mounted in a central opening and is surrounded by the peripheral part 52. Either the whole upper casing 5 is transparent as shown in FIG. 2, or only the display part 51 is transparent and a remaining part 53 of the upper casing 5 is painted. As a result, the painted remaining part 53 may be opaque or semi-transparent.

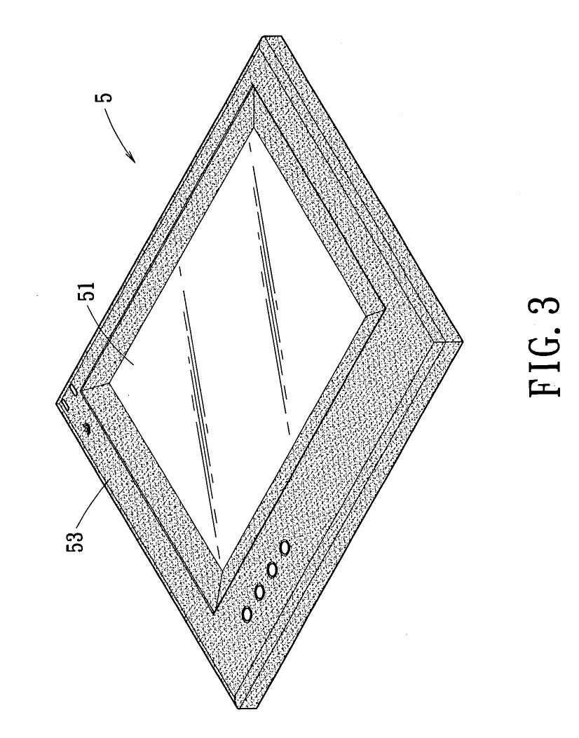

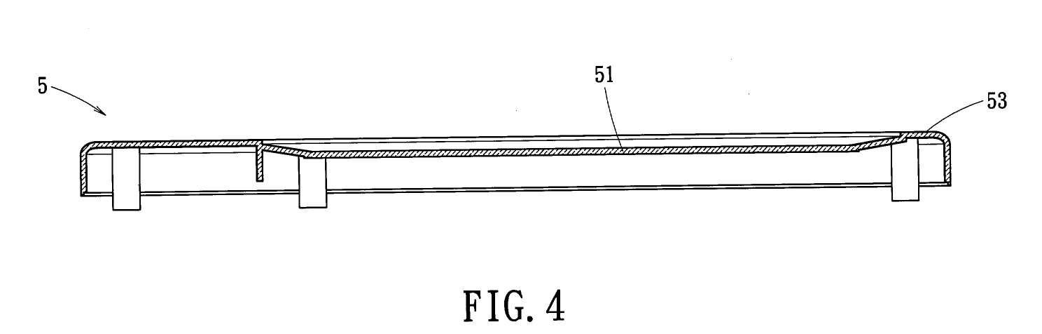

As illustrated in FIG. 4, which is a cross-sectional view of FIG. 3, the display part 51 is integrally formed with the remaining part 53 without the need of any additional film or opening. Therefore, there is no gap or slit between the display part 51 and the remaining part 53. In this embodiment of the invention, both exterior and interior of the remaining part 53 are painted. It is noted that not all of the surfaces of the remaining part 53 are necessarily painted, as long as the expected effect such as an aesthetic aspect is achieved.

Referring to FIG. 5 through FIG. 7, the touch panel display device includes the upper casing 5, a touch control module 6, a lower casing 7 and a circuit board 8. The upper and lower casings 5, 7 snap fit with each other to define a space therein for assembling the touch panel module 6 and the circuit board 8.

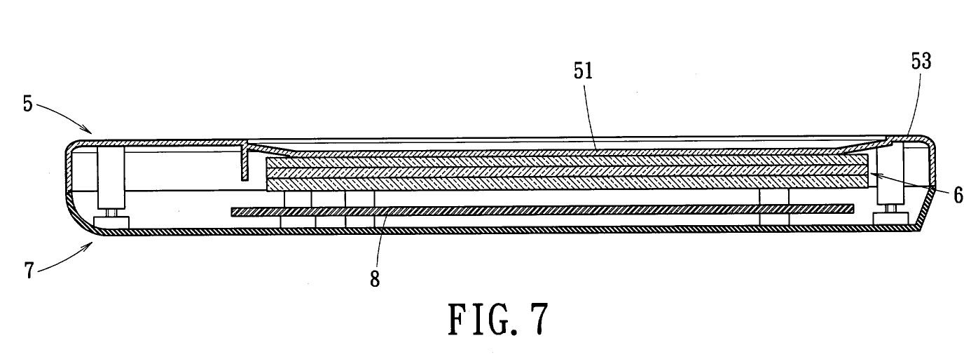

Referring to FIG. 7, a top of the touch control module 6 is attached to a bottom of the display part 51 by a conventional technique. Thereby, via the transparent display part 51, a user can see the displayed control context interfaced via the touch control module 6. Furthermore, the circuit board 8 is mounted between the touch control module 6 and the lower casing 7 to accomplish the touch panel display device of the invention.

The display part 51 of the upper casing 5 is further strengthened or tempered to provide improved properties such as wear resistance and shock resistance, which is favorable to the manual operation of the user performed on the display device.

As described above, the display part 51 and the remaining part 53 of the upper casing 5 are integrally formed without the need of any additional film or opening. The touch panel display device of the invention therefore is easily produced with a reduced cost.

Furthermore, there is no gap or slit between the display part 51 and the remaining part 53. Dust or moisture penetration is therefore reduced, and a consequent display failure is therefore prevented.

Since the upper casing 5 is made of a wear-resistant material and the display part 51 is further strengthened or tempered, the display part 51 located at a level lower than the peripheral part 52 or the remaining part 53 is effectively protected from being accidentally scratched or worn.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A touch panel display device, comprising:
an upper casing being made of transparent material and including a display part and a remaining part surrounding the display part;
a lower casing, mounted corresponding to the upper casing to define a space therein;
a touch control module, located under a bottom of the upper casing in the defined space; and
a circuit board, located between the touch control module and the lower casing in the defined space,
wherein the display part and the remaining part of the upper casing are integrally formed in a single body with no gap or slit there between, and a bottom of the display part is correspondingly attached to a top of the touch control module.

2. The touch panel display device of claim 1, wherein the remaining part of the upper casing is further painted.

3. The touch panel display device of claim 2, wherein an exterior of the remaining part is painted.

4. The touch panel display device of claim 2, wherein both exterior and interior of the remaining part are painted.

5. The touch panel display device of claim 1, wherein the display part of the upper casing is further strengthened or tempered to provide improved wear resistance or shock resistance.

6. The touch panel display device of claim 1, wherein the display part of the upper casing is located at a level lower than the remaining part.

7. The touch panel display device of claim 6, wherein the remaining part of the upper casing is further painted.

8. The touch panel display device of claim 7, wherein an exterior of the remaining part is painted.

9. The touch panel display device of claim 7, wherein both exterior and interior of the remaining part are painted.

10. The touch panel display device of claim 6, wherein the display part of the upper casing is further strengthened or tempered to provide improved wear resistance or shock resistance.
